(19) United States
(12) Patent Application Publication
(10) Pub. No.: US 2006/0031491 A1
(43) Pub. Date: Feb. 9, 2006

(54) Memory and memory handling for mobile phones

(76) Inventors: Peter Dam Nielsen, Kgs. Lyngby (DK); Christian Kraft, Hvidovre (DK)

Correspondence Address: PERMAN & GREEN, 425 POST ROAD, FAIRFIELD, CT, 06824, US

(21) Appl. No.: 10/867,829

(22) Filed: Jun. 15, 2004

(51) Int. Cl. G06F 15/173

(52) U.S. Cl. 709/225

(57) ABSTRACT

A method of accessing at a first portable communications terminal a data object comprising: a) requesting access at a first portable communications terminal to a data object; b) using a first data structure at the first portable communications terminal to identify a second remote and separate portable communications terminal where the data object is stored; c) fetching the data object from the second portable communications terminal to the first portable communications terminal.

### FIELD OF THE INVENTION

Embodiments of the invention relate to a memory and memory handling for mobile phones and other mobile communications terminals such as personal digital assistants.

### BACKGROUND TO THE INVENTION

It is becoming common for a user to own more than one mobile cellular telephone. For example, they may have a mobile telephone that they use in the office and another telephone that they have for casual use and another mobile telephone that they use when going out.

A problem arises, however, when data is stored on one terminal but not on another. This problem has been addressed so far by allowing a user to synchronize the phones so that they have the same content. One suitable protocol for this is SyncML. However, these results in each telephone having duplicate copies of the data on the other terminals. The more mobile telephones a user has the greater the amount of data that needs to be stored in each telephone and the more cumbersome it is to keep the telephones synchronized. The synchronization of the complete content of a memory can take a considerable amount of time. However, synchronization of part of the memory content requires the user to select the data for synchronization. This can be time consuming and frustrating as the user may have difficulty in remembering which files he or she wants to transfer and then in locating them in the filing system.

This problem becomes more acute as the amount of data stored on a mobile telephone increases as the size of data files increase. A telephone may store picture, video and sound files which are typically large. Furthermore, as camera technology advances and data transfer rates increase there is likely to be an ever increasing demand for memory in a mobile telephone.

### BRIEF DESCRIPTION OF THE INVENTION

Embodiments of the invention allow a user to use one mobile telephone to have on-demand access to data that is remotely stored on another one of the user's phones. Therefore there is no need to have a copy of all a user's data on each of his mobile telephones. This reduces memory use and can reduce costs by allowing the use of smaller memories. The use of a data structure ensures that a user doesn't have to remember which data is stored remotely and where it is stored. This allows access to data to be seamless from a user's perspective, although access to remotely stored data will generally have a greater access time that access to locally stored data.

According to one embodiment of the invention there is provided a method of accessing at a first portable communications terminal a data object comprising: a) requesting access at a first portable communications terminal to a data object; b) using a first data structure at the first portable communications terminal to identify a second remote and separate portable communications terminal where the data object is stored; and c) fetching the data object from the second portable communications terminal to the first portable communications terminal.

According to another embodiment of the invention there is provided a method of accessing at a first portable communications terminal a data object comprising: a) requesting access at a first portable communications terminal to a data object; b) using a first data structure at the first portable communications terminal to identify a second remote and separate portable communications terminal where the data object is stored; then, if the data object is a first type of data object:

i) moving the data object from the second portable communications terminal to the first portable communications terminal;

ii) storing the data object at the first portable communications terminal for access; and

iii) updating a second data structure at the second portable communications terminal to indicate that the data object is now stored in the first portable communications terminal,

but if the data object is a second type of data object

i) copying the data object from the second portable communications terminal to the first portable communications terminal if the data object is a second type;

ii) temporarily storing the data object of the second type at the first portable communications terminal for access; and

iii) deleting the data object of the second type at the first portable communications terminal after access.

According to another embodiment of the invention there is provided a method of accessing a data object at any one of a plurality of separate portable communications terminals, each of which maintains a data structure, the method comprising:

a) requesting access at a first one of the plurality of portable communications terminals to a first data object;

b) using the data structure at the first portable communications terminal to: identify a second one of the plurality of portable communications terminals where the data object is stored;

c) fetching the first data object from the second portable communications terminal to the first portable communications terminal;

d) storing the data object at the first portable communications terminal for access;

e) updating the data structure at each of the plurality of portable communications terminals to indicate that the data object is now stored in the first portable communications terminal;

f) accessing the data object at the first portable communications terminal;

g) terminating access to the data object at the first portable communications terminal;

h) requesting access at a third one of the plurality of portable communications terminals to the data object;

i) using the data structure at the third portable communications terminal to identify the first portable communications terminal where the data object is stored;

j) fetching the data object from the first portable communications terminal to the third portable communications terminal;

k) storing the data object at the third portable communications terminal for access; and

I) updating the data structure at each of the plurality of portable communications terminals to indicate that the data object is now stored in the third portable communications terminal.

According to another embodiment of the invention there is provided a system that allows any one of a plurality of separate portable communications terminals to access a data object, without storing the data object at each portable communications terminal, the system comprising:

a plurality of portable communications terminals;

a plurality of data objects each of which is stored in a single one of the plurality of portable communications terminals and is accessible by each of the plurality of portable communications terminals;

a data structure at each of the plurality of portable communications terminals indicating where each of the plurality of data objects is stored;

means for fetching a data object from one portable communications terminal to another.

According to another embodiment of the invention there is provided a portable communications terminal for memory sharing comprising: a memory for storing a data object for access by the portable communications terminal and each of one or more other separate portable communications terminals; means for fetching a first data object from the other portable communications terminal or one of the other portable communications terminals to the portable communications terminal for storage in the memory; and means for updating a data structure for indicating where the first data object is stored.

According to another embodiment of the invention there is provided a portable communications terminal for memory sharing with one or more other separate portable communications terminals, the portable communications terminal comprising: a memory for storing a data object for access by the portable communications terminal and each of one or more other separate portable communications terminals; means for fetching a first data object from the memory to the other portable communications terminal or one of the other portable communications terminals; and means for updating a data structure for indicating where the first data object is stored.

According to another embodiment of the invention there is provided a method of sending an email from a first portable communications terminal that shares a memory located in a second portable communications terminal with the second portable communications terminal, the method comprising:

using a first data structure at the first portable communications terminal to identify a second portable communications terminal where the data object is stored; fetching the data object from the second portable communications terminal to the first portable communications terminal; storing the data object at the first portable communications terminal for access; updating a second data structure at the second portable communications terminal to indicate that the data object is now stored in the first portable communications terminal; and attaching the data object to the email for sending.

According to another embodiment of the invention there is provided a method of sending an email from a first portable communications terminal that shares a memory located in a second portable communications terminal with the second portable communications terminal wherein the email on receipt comprises a data object attached by a server, the method comprising:

composing at a first portable communications terminal the content of an email; enabling a user to identify a data object for attachment to the email; using a first data structure at the first portable communications terminal to identify a second portable communications terminal where the data object is stored; and sending to a server information identifying the data object, identifying the second portable communications terminal where the data object is stored, and the content of the email.

According to another embodiment of the invention there is provided a method of sending an email from a first portable communications terminal that shares a memory located in a second portable communications terminal with the second portable communications terminal wherein the email on receipt comprises a data object attached by a server, the method comprising:

composing at a first portable communications terminal the content of an email; enabling a user to identify a data object for attachment to the email; using a first data structure at the first portable communications terminal to identify a second portable communications terminal where the data object is stored; sending to the second portable communications terminal a request to send the data object to the server; and sending to the server information identifying the data object, and the content of the email.

### BRIEF DESCRIPTION OF THE DRAWINGS

For a better understanding of the present invention reference will now be made by way of example only to the accompanying drawings in which:

FIG. 1 illustrates a system that allows any one of a plurality of separate cellular mobile telephones access to a data object, without storing the data object at each mobile telephone;

FIG. 2 illustrates the functional components of a cellular mobile telephone;

FIG. 3A illustrates a method of sending an email from the first terminal 10A with a data object 4 as an attachment; and

FIGS. 3B and 3C illustrate alternative methods of sending art email from the first terminal wherein the email on receipt comprises a data object but the data object is not attached by the first terminal but is attached by a server.

### DETAILED DESCRIPTION OF EMBODIMENTS OF THE INVENTION

A data object is a collection of data such as a file. Transferring a data object from an origin to a destination results in the data object being available at the destination. Transfer may be achieved by “copying” the data object from the origin to the destination so that it exists at the origin and a reproduction exists at the destination. Transfer may alternatively be achieved by “moving” the data object from the origin to the destination so that it exists at the destination but not at the origin. Movement of a data object may be achieved by copying the data object and then deleting the data object that exists at the origin. A “fetch” is a transfer initiated at the destination.

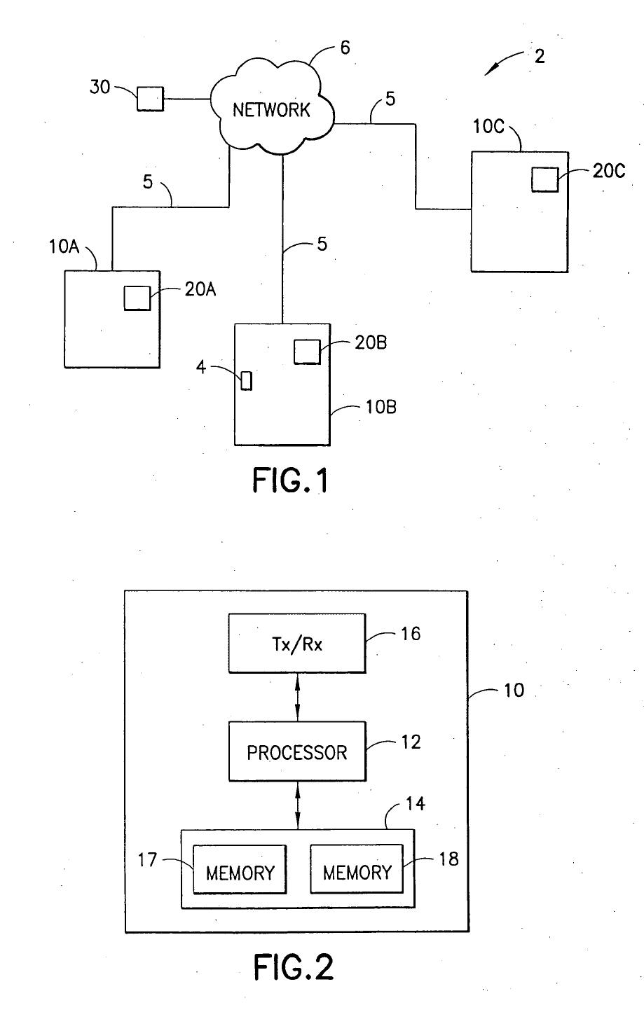

FIG. 1 illustrates a system 2 that allows any one of a plurality of separate terminals 10A, 10B, 10C to access a data object 4, without storing the data object 4 at each terminal.

The system 2 comprises a plurality of separate, distinct mobile communications terminals 10A, 10B, 10C. These terminals are associated together, for example, because they are under the ownership or control of one person. In this example, the terminals are hand-portable mobile cellular telephones, but they could also be personal digital assistants.

The system 2 also comprises a cellular telecommunications network 6 via which the mobile telephones 10A, 10B, 10C communicate with each other.

As illustrated in FIG. 2 each cellular mobile telephone 10 comprises: a processor 12; a memory 14 connected to be written to and read from by the processor 12; and a radio cellular transceiver 16 which is in two-way communication with the processor 12.

The memory 14 is typically logically divided into a shared portion 17 and a private portion 18. Data objects stored in the private portion 18 of the memory 14 of a particular terminal 10 are accessible only by that terminal. Data objects stored in the shared portion 17 of the memory 14 of a particular terminal 10A are shared. These shared data objects are accessible by that terminal and by each of the other terminals 10B, 10C. A data object is a collection of data such as a data file.

The memory 14 also stores a data structure 20 that indicates where shared data objects are located in the system 2. The data structure 20 is typically a table that identifies a data object by name, by file type and by terminal location.

The radio cellular transceiver 16 uses the cellular radiotelephone network 6 to create a communication channel, to other associated terminals, through which a data object can moved. A data object 4 can, for example, thus be moved from storage in the shared portion 17 of the memory 14 of any one of the terminals 10A, 10B, 10C to storage in the shared portion 17 of the memory 14 of any other one of the terminals 10A, 10B, 10C. The communication channels 5 between the terminals 10A, 10B and 10C are preferably packet data channels that are always on in the sense that a virtual/logical channel exists even if data is not being transmitted.

Referring back to FIG. 1, each of the terminals 10A, 10B and 10C has a respective data structure 20A, 20B and 20C. Each of these data structures indicates where each of the plurality of shared data objects are stored in the system 2.

If a data object 4 is stored in the shared portion 17 of the memory 14 of the second terminal 10B, it's content is accessible locally by the terminal 10B and remotely by the first and thirds terminals 10A and 10C, although there is only a single version of the data object 4 in the system 2. If the data object 4 is moved from the second terminal 10B to the first terminal 10A, for example, then the data structures 20A, 20B, 20C in each of the terminals 10A, 10B and 10C is updated to indicate where the data object is now stored. This update occurs at each of the terminals 10A, 10B and 10C at substantially the same time.

The movement of a data object 4 from the second terminal 10B to the first terminal 10A may occur as a result of the first terminal 10A requesting access to the data object 4.

When a request to access a data object 4 is made at the first terminal 10A, the first terminal 10A uses its data structure 20A to identify the terminal (the second terminal 10B) where the required data object 4 is stored. The first terminal 10A pulls the data object 4 from the shared portion 17 of the memory 14 of the second terminal 10B and stores it in the shared portion 17 of its memory 14. The second terminal 10B updates its data structure 20B to indicate that the data object 4 is now stored in the first terminal 10A. It may also inform the other terminals 10A and 10C of this, which will update their respective data structures 20A, 20C. The first terminal 10A then accesses the locally stored data object 4. When the access is terminated the data object 4 remains stored in the shared portion 17 of the memory 14 of the first terminal 10A until it is moved to another terminal 10B, 10C as a result of an access request at that terminal.

Likewise, if a request to access a data object is made at the third terminal 10C, the third terminal 10C uses its data structure 20C to identify the terminal where the required data object is stored. The third terminal 10C pulls the required data object from the shared portion 17 of the memory 14 of the identified terminal and stores it in the shared portion 17 of its memory. The identified terminal updates its data structure to indicate that the data object is now stored in the third terminal 10C. It may also inform the other terminals of this, which will update their data structures. The data object may be the same as the data object 4 referred to in the preceding paragraph or a different data object. The third terminal 10C then accesses the locally stored data object. When the access is terminated the data object remains stored in the shared portion 17 of the memory 14 of the third terminal 10C until it is moved to another terminal 10A, 10B as a result of an access request at that terminal.

Likewise, if a request to access a data object is made at the second terminal 10B, the second terminal 10B uses its data structure 20B to identify the terminal where the required data object is stored. The second terminal 10B pulls the required data object from the shared portion 17 of the memory 14 of the identified terminal and stores it in the shared portion 17 of its memory 14. The identified terminal updates its data structure to indicate that the data object is now stored in the second terminal 10B. It may also inform the other terminals of this, which will update their data structures. The data object may be the same as the data object 4 referred to in the preceding paragraph or a different data object. The second terminal 10B then accesses the locally stored data object. When the access is terminated the data object remains stored in the shared portion 17 of the memory 14 of the second terminal 10B until it is moved to another terminal 10A, 10C as a result of an access request at that terminal.

Thus a single copy of a shared data object exists within the system, stored in the shared portion 17 of the memory 14 of one of the terminals 10A, 10B, 10C The single copy is moved to where it is required for access. This saves memory.

Typically when a terminal tries to access a data object, the terminal will attempt to access it within its internal file structure and if this fails it then uses the data structure 20 to identify the terminal where the data object is stored.

Alternatively, when a terminal tries to access a data object, the terminal will use the data structure 20 to identify whether the data object is stored locally at the first terminal or remotely, and if it is stored remotely to identify the terminal where the data object is remotely stored.

As the data structure must be up to date to correctly manage access requests to remote data objects, it is necessary to update the data structure when a terminal is switched on.

The same common data structure 20 may be used in each of the first, second and third terminals 10A, 10B, 10C as their respective data structures 20A, 20B, 20C. In this case, the common data structure 20 is synchronized between the terminals. That is, when an update occurs at the data structure of one terminal, the data structures at the other terminals is updated. This may be achieved by copying the updated data structure to each of the other terminals.

In a different implementation of the invention, only a single copy of a shared data object of a first type exists within the system, stored in the shared portion 17 of the memory 14 of one of the terminals 10A, 10B, 10C, whereas multiple copies of a shared data object of a second type may exist within the system. This is because movement of the data objects of the second type is restricted and if access is required by another terminal a duplicate, temporary copy is transferred to the other terminal for access.

Data objects of the first type may be stored in any terminal, but all the data objects of a second type are stored only in one terminal, say the second terminal 10B. This may be useful if a user wishes to store all his music files on his ‘leisure’ mobile telephone and all his spreadsheet documents on his ‘business’ mobile telephone, for example.

The data objects of the first type may be treated as described above with reference to FIG. 1. A single copy exists within the system 2 and the single copy is moved to where it is required for access.

The data objects of the second type are treated differently. A temporary copy may exist within the system. When the first terminal 10A requests access to the data object 4, which is of a second type, it uses the first data structure 20A to identify the terminal (the second terminal 10B) where the data object is stored. A request is sent to the second terminal 10B which identifies the type of data object requested and determines whether the requested data object should be moved or copied. Data objects of the first type would be moved and data objects of the second type would be copied. The requested data object 4, which is of the second type, is copied from the second terminal 10B to the first terminal 10A. The copied data object is then temporarily stored at the first terminal for access. After the first terminal 10A completes a read access the data object is deleted at the first terminal. After the first terminal completes an editing access, the first terminal replaces the data object 4 at the second terminal 10B with the edited data object at the first terminal 10A and then deletes the edited data object at the first terminal 10A.

It is also necessary to create temporary copies of data objects if multiple ones of the terminals 10A, 10B, 10C are to be given concurrent access to a data object.

The management of concurrent access may be achieved using semaphores. A pair of semaphores, a write semaphore and a read semaphore, are associated with each shared data object. The write semaphore has a value of 1 or 0. A value of 1 indicates that the data object is currently being accessed for editing. A value of 0 indicates that the data object is not currently being accessed for editing. The read semaphore has a value 0, 1, 2 . . . N. A value of 0 indicates that the data object is not currently being accessed for reading only. A value of m>0 indicates the number of terminals that are concurrently accessing the data object for reading only. The semaphore values may be stored in the common data structure 20 or may be stored in a semaphore data structure separate to the common data structure that is stored only where the data object to which they relate is stored.

If the write semaphore and the read semaphore are both 0, then the associated data object is not being accessed at that time. If a terminal is trying to access an associated data object at this time, then access will be allowed and the data object will be moved to the requesting terminal as described previously.

If the write semaphore value is 1, when a terminal is trying to access an associated data object, then access will be denied or delayed until the editing access is completed. The editing access is an exclusive access. Alternatively, read-only access may be given to the unedited version of the data object with a warning that it is being edited.

If the write semaphore value is 0 and the read semaphore value is >0, when a terminal is trying to access an associated data object, then access will be allowed and the data object will be temporarily copied to the requesting terminal and then deleted after the access has been completed. Reading access is a non-exclusive access.

For example, when the first terminal 10A requests access to the data object 4, it uses the first data structure 20A to identify the terminal (the second terminal 10B) where the data object is stored. A request is sent to the second terminal 10B which identifies the semaphore values associated with the requested data object.

If the write semaphore value is 0 and the read semaphore value is 0, then the requested data object 4 is moved from the second terminal 10B to the first terminal 10A where it is stored for access. After the first terminal 10A completes a read access the data object remains stored at the first terminal.

If the write semaphore value is 1, then the requested data object 4 is copied from the second terminal 10B to the first terminal 10A and read-only access is allowed. The copied data object is then temporarily stored at the first terminal for access. After the first terminal 10A completes a read access the data object is deleted at the first terminal 10A.

If the write semaphore value is 0 and the read semaphore value is greater than 0, then the requested data object 4 is copied from the second terminal 10B to the first terminal 10A. The copied data object is then temporarily stored at the first terminal for access. After the first terminal 10A completes a read access the data object is deleted at the first terminal.

In other implementations, a single access semaphore may be used. This semaphore is used to indicate when the data object 4 is being accessed for reading or writing. In this implementation, the access semaphore may be used to prevent concurrent access to the data object. Alternatively, concurrent access may be allowed but the data object may be modified while it is being read.

The above described access procedures involve moving and copying data objects to terminals. Each terminal only has a certain memory capacity. If the memory capacity is exceeded data may be lost or as the capacity is approached it may not be possible to store a data object as there is insufficient capacity. Each terminal may therefore be arranged to push data objects to another terminal or terminals as its memory capacity is approached. Typically, the terminal will select data objects for transfer either on their type and/or the time since they were last accessed. It may therefore be desirable to have a time stamp for the shared data objects that identifies when they were last accessed. When a data object is moved to create more memory capacity at a terminal, it is necessary to update the common data structure indicating where the moved data object is now stored.

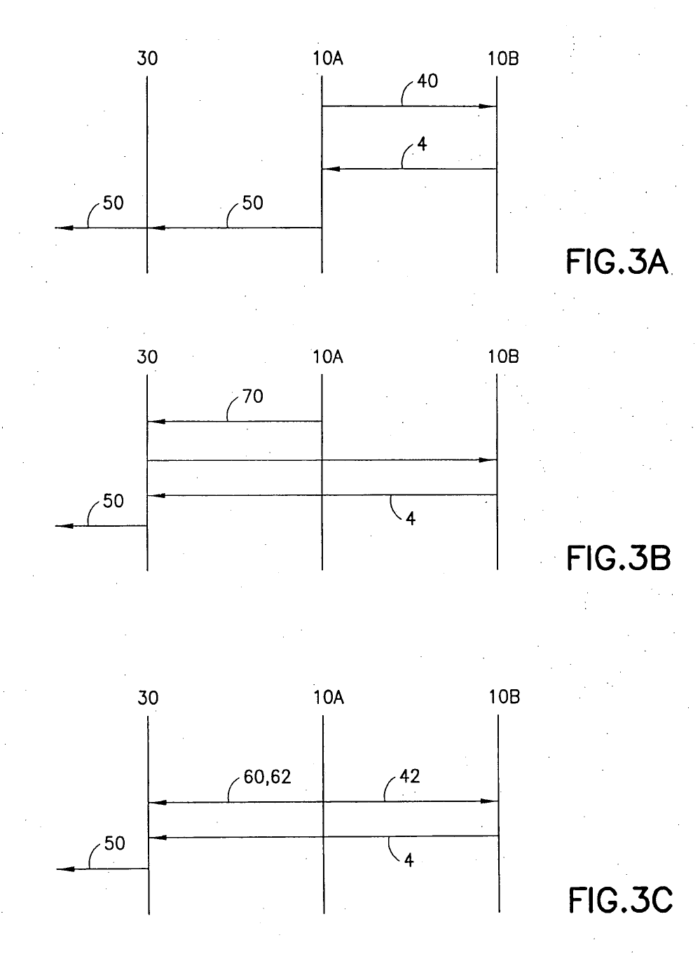

FIG. 3A illustrates a method of sending an email from the first terminal 10A with a data object 4 as an attachment. The first terminal 10A uses the first data structure 20A to identify the terminal (the second terminal 10B) where the data object 4 is stored. It then sends to the second terminal 10B a request 40 for access to the data object. The second terminal 10B responds by moving the data object 4 from the second terminal to the first terminal, where it is stored. The common data structure is updated at the first and second terminals to indicate that the data object is now stored in the first terminal. The first terminal then attaches the locally stored data object to the email 50 and sends it to the server 30.

FIG. 3B illustrates a method of sending an email from the first terminal 10A wherein the email on receipt comprises a data object 4 but the data object 4 is not attached by the first terminal 10A but is attached by a server 30 The email text content 60 is composed at the first terminal. A user of the first terminal selects a data object for attachment to the email. The first terminal 10A uses the first data structure 20A to identify the terminal (the second terminal 10B) where the data object 4 is stored. The first terminal then sends to the server 30 information 70 identifying the data object, identifying the second terminal where the data object is stored, and the content of the email. The server 30 then pulls a copy of the required data object 4 from the second terminal 10B and attaches it to the email content before sending the email. In this process, the data object is only transferred once, which is more efficient if the size of the data object is large.

FIG. 3C illustrates a method of sending an email from the first terminal 10A wherein the email on receipt comprises a data object but the data object is not attached by the first terminal but is attached by a server 30. The email text content 60 is composed at the first terminal 10A. A user of the first terminal selects a data object for attachment to the email. The first terminal 10A uses the first data structure 20A to identify the terminal (the second terminal 10B) where the data object is stored. The first terminal 10A then sends to the server 30 the text content 60 of the email and information 62 identifying the data object. The first terminal 10A also sends to the second terminal 10B a request 42 identifying the data object and the second terminal 10B responds by pushing a copy of the identified data object 4 to the server 30. The server 30 attaches the copy of the data object 4 received from the second terminal 10B and attaches it to the email content before sending the email 50.

The virtual connection 5 between the terminals 10A, 10B, 10C, can be used to communicate information concerning user selected events from one terminal to another. A menu function allows the user, who is currently using the first mobile telephone 10A, to select for each one of his other mobile telephones 10B, 10C which events he wishes to be informed about at the first mobile telephone 10A. Examples of selectable events include: the other telephone is switched on/off; the other telephone's battery is low; a calendar event occurs at the other telephone; a SMS is received at the other telephone; the other telephone has moved (e.g. its local base station has changed); the other telephone's user profile has changed etc. The first mobile telephone 10A informs the other mobile telephones of the user-selected events. When a selected event occurs at one of the other mobile telephones 10B, 10C the first mobile telephone 10A is informed and an alert is produced by the first mobile telephone 10A to alert the user to the event. The first mobile telephone 10A may be informed immediately when a selected event occurs, or the other terminal may compile information identifying the occurrence of selected events and then send the compiled information periodically or whenever the mobile telephone is next updating the common data structure.

Although embodiments of the present invention have been described in the preceding paragraphs with reference to various examples, it should be appreciated that modifications to the examples given can be made without departing from the spirit and scope of the invention as claimed. For example the memory 14 may be a removable memory such as a memory card.

I/we claim:

1. A method of accessing at a first portable communications terminal a data object comprising:
a) requesting access at a first portable communications terminal to a data object;
b) using a first data structure at the first portable communications terminal to identify a second remote and separate portable communications terminal where the data object is stored; and
c) fetching the data object from the second portable communications terminal to the first portable communications terminal.

2. A method as claimed in claim 1, wherein the first data structure and the second data structure are a common data structure that is shared by a plurality of portable communications terminals.

3. A method as claimed in claim 1, wherein first data structure comprises a semaphore indicating that the data object is exclusively in use, while the first portable communications terminal is accessing the data object.

4. A method as claimed in claim 1, wherein first data structure comprises a semaphore indicating that the data object is non-exclusively in use, while the first portable communications terminal is accessing the data object.

5. A method as claimed in claim 1, further comprising:
detecting when the memory at the first portable communications terminal has a predetermined capacity remaining for storage of new data;
fetching a data object from the first portable communications terminal to another portable communications terminal to increase the available storage capacity; and
updating the first data structure.

6. A method as claimed in claim 1, wherein the first portable communications terminal is a mobile cellular telephone.

7. A method as claimed in claim 6, wherein the second portable communications terminal is a mobile cellular telephone.

8. A method as claimed in claim 1, wherein the first portable communications terminal is a personal digital assistant.

9. A method as claimed in claim 6, wherein the second portable communications terminal is a personal digital assistant.

10. A method as claimed in claim 1, wherein the first portable communications terminal and second portable communications terminal maintain a communication channel via a cellular radiotelephone network through which the data object is fetched.

11. A method as claimed in claim 1, wherein fetching the data object from the second portable communications terminal to the first portable communications terminal involves copying the data object from the second portable communications terminal to the first portable communications terminal, followed by temporarily storing the data object at the first portable communications terminal for access.

12. A method as claimed in claim 1, wherein fetching the data object from the second portable communications terminal to the first portable communications terminal involves fetching the data object from the second portable communications terminal to the first portable communications terminal, followed by:
d) storing the data object at the first portable communications terminal for access; and
e) updating a second data structure at the second portable communications terminal to indicate that the data object is now stored in the first portable communications terminal.

13. A method as claimed in claim 12, further comprising, after fetching the data object,
f) updating the first data structure at the first portable communications terminal to indicate that the data object is now stored in the first portable communications terminal

14. A method as claimed in claim 12, wherein the step of updating the second data structure at the second portable communications terminal occurs as a result of a common data structure being updated at each one of the plurality of associated portable communications terminals

15. A method as claimed in claim 12, where steps d) and e) occur if the first portable communications terminal is the only portable communications terminal accessing the data object.

16. A method as claimed in claim 12, where steps d) and e) occur if the first portable communications terminal is the first one of a plurality of portable communications terminals that concurrently access the data object for reading.

17. A method as claimed in claim 12, where steps d) and e) occur if the first portable communications terminal is accessing the data object for editing.

18. A method of accessing at a first portable communications terminal a data object comprising:
a) requesting access at a first portable communications terminal to a data object;
b) using a first data structure at the first portable communications terminal to identify a second remote and separate portable communications terminal where the data object is stored;
then, if the data object is a first type of data object:
i) moving the data object from the second portable communications terminal to the first portable communications terminal;
ii) storing the data object at the first portable communications terminal for access; and
iii) updating a second data structure at the second portable communications terminal to indicate that the data object is now stored in the first portable communications terminal,
but if the data object is a second type of data object
i) copying the data object from the second portable communications terminal to the first portable communications terminal if the data object is a second type;
ii) temporarily storing the data object of the second type at the first portable communications terminal for access; and
iii) deleting the data object of the second type at the first portable communications terminal after access.

19. A method of accessing a data object at any one of a plurality of separate portable communications terminals, each of which maintains a data structure, the method comprising:
a) requesting access at a first one of the plurality of portable communications terminals to a first data object;
b) using the data structure at the first portable communications terminal to identify a second one of the plurality of portable communications terminals where the data object is stored;
c) fetching the first data object from the second portable communications terminal to the first portable communications terminal;
d) storing the data object at the first portable communications terminal for access;
e) updating the data structure at each of the plurality of portable communications terminals to indicate that the data object is now stored in the first portable communications terminal;
f) accessing the data object at the first portable communications terminal;
g) terminating access to the data object at the first portable communications terminal;
h) requesting access at a third one of the plurality of portable communications terminals to the data object;
i) using the data structure at the third portable communications terminal to identify the first portable communications terminal where the data object is stored;
j) fetching the data object from the first portable communications terminal to the third portable communications terminal;
k) storing the data object at the third portable communications terminal for access; and
l) updating the data structure at each of the plurality of portable communications terminals to indicate that the data object is now stored in the third portable communications terminal.

20. A system that allows any one of a plurality of separate portable communications terminals to access a data object, without storing the data object at each portable communications terminal, the system comprising:
a plurality of portable communications terminals;
a plurality of data objects each of which is stored in a single one of the plurality of portable communications terminals and is accessible by each of the plurality of portable communications terminals;
a data structure at each of the plurality of portable communications terminals indicating where each of the plurality of data objects is stored;
means for fetching a data object from one portable communications terminal to another.

21. A system as claimed in claim 20, further comprising: means for fetching a data object from one portable communications terminal to another; and means for updating the data structure, after a data object is moved, to indicate where the data object is stored.

22. A system as claimed in claim 20, further comprising: means for updating the data structure in each of the plurality of portable communications terminals at substantially the same time.

23. A system as claimed in claim 20, wherein the means for fetching a data object comprises a cellular radiotelephone network.

24. A system as claimed in claim 20, further comprising means for detecting a semaphore indicating that the first data object is exclusively in use.

25. A system as claimed in claim 20, further comprising means for detecting a semaphore indicating that the first data object is non-exclusively in use.

26. A system as claimed in claim 20, further comprising means for fetching one or more data objects from a first portable communications terminal to another portable communications terminal when the memory capacity of the first portable communications terminal becomes limited.

27. A system as claimed in claim 20, wherein at least one of the plurality of portable communications terminals is a mobile cellular telephone.

28. A system as claimed in claim 20, wherein at least one of the plurality of portable communications terminals is a personal digital assistant.

29. A portable communications terminal for memory sharing comprising:
a memory for storing a data object for access by the portable communications terminal and each of one or more other separate portable communications terminals;
means for fetching a first data object from the other portable communications terminal or one of the other portable communications terminals to the portable communications terminal for storage in the memory; and
means for updating a data structure for indicating where the first data object is stored.

30. A portable communications terminal for memory sharing with one or more other separate portable communications terminals, the portable communications terminal comprising:
a memory for storing a data object for access by the portable communications terminal and each of one or more other separate portable communications terminals;
means for fetching a first data object from the memory to the other portable communications terminal or one of the other portable communications terminals; and
means for updating a data structure for indicating where the first data object is stored.

31. A method of sending an email from a first portable communications terminal that shares a memory located in a second portable communications terminal with the second portable communications terminal, the method comprising:
using a first data structure at the first portable communications terminal to identify a second portable communications terminal where the data object is stored;
fetching the data object from the second portable communications terminal to the first portable communications terminal; and
attaching the data object to the email for sending.

32. A method of sending an email from a first portable communications terminal that shares a memory located in a second portable communications terminal with the second portable communications terminal wherein the email on receipt comprises a data object attached by a server, the method comprising:
composing at a first portable communications terminal the content of an email;
enabling a user to identify a data object for attachment to the email;
using a first data structure at the first portable communications terminal to identify a second portable communications terminal where the data object is stored; and
sending to a server information identifying the data object, identifying the second portable communications terminal where the data object is stored, and the content of the email.

33. A method of sending an email from a first portable communications terminal that shares a memory located in a second portable communications terminal with the second portable communications terminal wherein the email on receipt comprises a data object attached by a server, the method comprising:
composing at a first portable communications terminal the content of an email;
enabling a user to identify a data object for attachment to the email;
using a first data structure at the first portable communications terminal to identify a second portable communications terminal where the data object is stored;
sending to the second portable communications terminal a request to send the data object to the server; and
sending to the server information identifying the data object, and the content of the email.
